(19) United States
(12) Patent Application Publication
(10) Pub. No.: US 2026/0360772 A1
(43) Pub. Date: Nov. 12, 2026

(54) PROTECTIVE SURFACES FOR ELECTROCHEMICAL COMPONENTS AND CELLS

(71) Applicant: UNIVERSITY OF CONNECTICUT, Farmington, CT (US)

(72) Inventors: Xiao-Dong Zhou, Columbia, CT (US); Nengneng Xu, Vernon, CT (US); Yudong Wang, Willimantic, CT (US); Zizhou He, Willimantic, CT (US)

(21) Appl. No.: 19/673,322

(22) Filed: May 11, 2026

Related U.S. Application Data
(60) Provisional application No. 63/802,894, filed on May 9, 2025.
(60) Provisional application No. 63/802,905, filed on May 9, 2025.

(51) Int. Cl. H01M 8/0245; C25B 13/07; H01M 8/0232; H01M 8/0236; H01M 8/1246; C25B 1/04; H01M 8/12

(52) U.S. Cl. CPC H01M 8/0245; C25B 13/07; H01M 8/0232; H01M 8/0236; H01M 8/1246; C25B 1/04; H01M 2008/1293

(57) ABSTRACT

The present disclosure describes an electrochemical component of an electrochemical cell, including a substrate forming at least a portion of an electrochemical component and a protective surface region disposed on the electrochemical component. The protective surface region includes a degradation retardant, such as a porous layer of metal oxide particles, to inhibit a degradation mechanism of the electrochemical component during operation of an electrochemical device. The degradation mechanism can include chromium evaporation, stainless steel oxidation, an interfacial side reaction, transition metal dissolution, electrolyte decomposition, gas evolution, or a combination thereof. The substrate can include stainless steel or micron sized lithium cathode particles. The metal oxide particles can include an oxide of cobalt and manganese, a spinel layer, or nanometer sized oxide particles including gamma alumina (γ-Al₂O₃), titania (TiO₂), zirconia (ZrO₂), silica (SiO₂), tungsten oxide (WO₃), or combinations thereof.

### STATEMENT REGARDING FEDERALLY SPONSORED RESEARCH

This invention was made with government support under DE-AR0001774 awarded by the U.S. Department of Energy. The government has certain rights in the invention.

### CROSS REFERENCE TO RELATED APPLICATIONS

This application claims the benefit of and priority to United States Patent Application Nos. 63/802,894 and 63/802,905, each of which was filed on May 9, 2025, the contents of each of which are incorporated by reference herein in their entirety for all purposes.

### BACKGROUND OF THE INVENTION

### 1. Field of the Invention

The disclosure relates to protective surface regions for electrochemical components and, more particularly, to degradation retardant based surface regions for stainless steel components and lithium cathode active material particles.

### 2. Description of the Related Art

Solid oxide cells, including solid oxide fuel cells (SOFCs) and solid oxide electrolysis cells (SOECs), are electrochemical devices that operate at high temperatures (600 to 1000°C) and are employed for efficient energy conversion and storage applications. A typical solid oxide cell stack comprises multiple repeating units of ceramic cells and metallic interconnects. The metallic interconnects serve to electrically connect adjacent cells and to provide gas separation and mechanical stability. However, due to prolonged exposure to high-temperature oxidizing and reducing environments, these interconnects are subject to corrosion, chromium evaporation, and interfacial degradation, all of which contribute to increased electrical resistance and reduced stack performance over time. Various approaches have been explored to mitigate such degradation, including the application of protective coatings to the surface of the metallic interconnects. These coatings, often composed of conductive oxides or ceramic barrier layers, function to inhibit corrosion and chromium migration while maintaining electrical conductivity.

Lithium ion batteries are widely used as energy storage devices in a variety of applications, including portable electronics, electric vehicles, and grid storage systems. The performance of these batteries is largely determined by the electrochemical behavior of the active electrode materials, which participate directly in lithium intercalation and deintercalation reactions. However, many active materials suffer from capacity fade, structural degradation, and side reactions with the electrolyte during repeated charge-discharge cycling, which limit the overall energy density, rate capability, and cycle life of the battery.

In an effort to enhance the durability and electrochemical stability of active electrode materials, various surface modification techniques have been explored. These include chemical coatings, atomic layer deposition, and vapor-phase treatments. While such approaches have shown some success in improving cycle life and suppressing interfacial side reactions, they are often limited by high processing costs, complex procedures, poor scalability, or insufficient control over coating thickness and uniformity.

It is therefore desirable to modify the surface properties of various electrochemical components that are used in electrochemical devices such as the electrodes used in fuel cells, batteries, and electrolyzers, as well as supporting structure that is stainless steel thereby to improve their overall energy density, rate capability, and/or extend their life cycle performance. Despite advances in protective coating formulations and surface modifications, there remains a need for better protected electrochemical components that can be made by a process that is scalable, cost-effective, and has uniform manufacturing methods, particularly in a manner that ensures long-term stability under operating conditions.

### SUMMARY OF THE INVENTION

In one aspect, the present disclosure describes an electrochemical component for use in an electrochemical device such as an electrochemical cell. The electrochemical component includes a substrate and a protective surface region disposed on the substrate. In various embodiments, the substrate can be stainless steel. In another example, the substrate is a plurality of lithium cathode active material particles. The protective surface region can include a degradation retardant. The protective surface region can include metal oxide particles. For example, the degradation retardant can be a porous layer of metal oxide particles. The degradation retardant can inhibit a degradation mechanism of the electrochemical component during operation of an electrochemical device.

In some embodiments, the degradation mechanism can include chromium evaporation, stainless steel oxidation, an interfacial side reaction, transition metal dissolution, electrolyte decomposition.

In some embodiments, the substrate can be stainless steel. In some embodiments, the stainless steel substrate can be a metallic interconnect of a solid oxide cell. In some embodiments, the metal oxide particles can include cobalt and manganese, e.g. an oxide of cobalt and manganese. The oxide of cobalt and manganese can have the formula: (Co,Mn)Oₓ, wherein x is 1 to 2. In some embodiments, x can be 1.33 to 1.9. In some embodiments, the protective surface region can include a spinel layer.

In various embodiments, the substrate can include a plurality of lithium cathode active material particles. The lithium cathode active material particles can be micron sized particles. In some embodiments, the nanometer sized oxide particles can have an average particle size of 2 nanometers to 20 nanometers. The micron sized lithium cathode particles can include nickel manganese cobalt oxide, nickel cobalt aluminum oxide, lithium cobalt oxide, or a combination thereof. The micron sized lithium cathode particles can have an average particle size of 5 micrometers to 40 micrometers.

The metal oxide particles can include a nickel manganese cobalt oxide mixture with nanometer sized oxide particles that are nanometer sized. The nanometer sized oxide particles can include gamma alumina (γ-Al₂O₃), titania (TiO₂), zirconia ₍ZrO₂), silica (SiO₂), tungsten oxide (WO₃), or combinations thereof disposed on micrometer-sized lithium cathode active material particles.

In some embodiments, the substrate can be selected from a stainless steel interconnect, a stainless steel component of a gas manifold, a stainless steel component of a compression plate, a stainless steel component of a current collector, and a stainless steel component of a sealing structure.

In one aspect, the present disclosure describes an electrochemical cell generally including an anode; a cathode; an electrolyte in electrical communication with each of the anode and the cathode; and an electrochemical component that includes a substrate forming at least a portion of an electrochemical component to inhibit a degradation mechanism of the electrochemical component during operation of the electrochemical cell. This aspect inlcudes a protective surface region disposed on the electrochemical component.

In this aspect, the substrate can be selected from a stainless steel interconnect, and a stainless steel component of a gas manifold, a compression plate, a current collector, and a sealing structure.

Also disclosed herein is a method of coating a metal substrate, the method comprising dissolving a cobalt salt in an aqueous solution; dissolving a salt comprising potassium and manganese in the aqueous solution; spraying or screen printing the solution on a metal substrate to form a thin coating; or dip coating the metal substrate with the solution to form a thick coating; and drying the thick coating or the thin coating to remove the aqueous solution and reaction by-products.

These and other features will be more clearly understood from the following drawings, detailed description and example as well as the appended claims.

### BRIEF DESCRIPTION OF THE DRAWINGS

The features and advantages of the present disclosure will be apparent from the following description taken in conjunction with the accompanying drawings.

FIG. 1 is a schematic of some embodiments of a solid oxide fuel cell including one or more electrochemical components having a protective surface region.

FIG. 2 is a graph that depicts the effect of coating time on the oxidation behavior of stainless steel.

FIG. 3 is a graph that depicts the effect of coating temperature on the oxidation behavior of stainless steel.

FIG. 4 is a graph that depicts the effect of cobalt salt on the oxidation behavior of stainless steel.

FIG. 5 is a graph that depicts the effect of Co:Mn ratio in the coating solution on the oxidation behavior of stainless steel.

FIG. 6 is a schematic diagram that depicts the mixing of NMC particles with γ-Al₂O₃ particles to form a coating of the γ-Al₂O₃ particles on the NMC particles.

FIG. 7 depicts a series of scanning electron micrographs that show γ-Al₂O₃ particles disposed on NMC particles when subjected to mixing for different time periods.

FIG. 8 depicts a series of scanning electron micrographs that show different amounts of γ-Al₂O₃ particles disposed on NMC particles.

FIG. 9 depicts scanning electron micrographs of cathode active material particles coated with 1 weight percent Al₂O₃, including NMC811 particles coated with 1 weight percent Al₂O₃ and N_{0.88}C_{0.09}A_{0.03} particles coated with 1 weight percent Al₂O₃.

### DETAILED DESCRIPTION OF THE INVENTION

Disclosed herein are electrochemical components and methods of forming protective surface regions for electrochemical components. Electrochemical devices can include metallic, ceramic, and particulate components that operate in chemically reactive, thermally demanding, and/or electrochemically active environments. During operation, such components can be subject to degradation mechanisms including oxidation, corrosion, chromium evaporation, interfacial side reactions, transition metal dissolution, electrolyte decomposition, gas evolution, impedance growth, capacity fade, or loss of active material. Protective surface regions for such components can inhibit one or more degradation mechanisms while preserving functional properties of the underlying component, including electrical conductivity, ion transport, heat transfer, structural integrity, and compatibility with scalable manufacturing processes.

In some embodiments, the technology disclosed herein addresses these considerations by providing oxide-containing protective surface regions that are formed on selected electrochemical substrates. For example, a stainless steel substrate, such as an interconnect or other stainless steel component of a solid oxide cell, can be provided with a cobalt-manganese oxide-containing surface region that can be heat treated to form a spinel layer, which can be specifically designed and/or configured to reduce oxidation or chromium transport while maintaining electrical functionality at elevated temperature.

In another example, a plurality of lithium cathode active material particles can be provided with nanometer sized oxide particles, such as gamma alumina particles, disposed on micrometer sized cathode active material particles by resonant acoustic mixing in the absence of a solvent, thereby forming a surface-protected cathode mixture that can reduce direct contact between reactive cathode surfaces and electrolyte during battery operation.

Compared with techniques that require complex coating operations, solvent-intensive particle treatments, and/or poorly controlled surface modification, the disclosed technology supports formation of protective oxide-containing regions with controlled thickness, morphology, and/or surface coverage on different electrochemical component substrates. These features can reduce processing complexity, reduce use of solvent and associated drying operations, and support uniform protective layer formation while inhibiting degradation mechanisms that affect long-term performance, durability, and scalability of electrochemical devices.

Industries that can benefit from the technology disclosed herein include electrochemical energy conversion, electrochemical energy storage, solid oxide fuel cell manufacturing, solid oxide electrolysis, lithium ion battery manufacturing, electric vehicle systems, portable electronics, grid-scale energy storage, and electrochemical reactor systems. In these settings, as mentioned above, electrochemical components can operate in environments that impose thermal, chemical, and/or electrochemical stresses on metallic surfaces, ceramic interfaces, electrode particles, and current-conducting structures. For example, stainless steel components of solid oxide cell stacks can be exposed to elevated-temperature oxidizing, reducing, or humidified atmospheres while providing electrical connection, gas separation, and mechanical support. Lithium cathode active material particles can be exposed to repeated lithium insertion and extraction, electrolyte contact, elevated voltages, and cycling conditions that promote interfacial reactions. The technology disclosed herein provides protective oxide-based surface regions for such electrochemical components so that stainless steel substrates, lithium cathode active material particles, cathode active layers, current collectors, interconnects, gas manifold components, compression plates, and sealing structures can be adapted for longer-duration operation in electrochemical devices.

Advantages and technical effects of the technology disclosed herein include inhibition of degradation mechanisms that can reduce performance, durability, conductivity, structural integrity, or cycle life of electrochemical components and cells. In some embodiments, oxide-based protective surface regions can reduce stainless steel oxidation, reduce chromium evaporation, trap volatile chromium-containing species, reduce corrosion, or maintain electrical functionality of stainless steel components at elevated operating temperatures. In some embodiments, nanometer sized oxide particles disposed on micrometer sized lithium cathode active material particles can reduce direct contact between reactive cathode surfaces and electrolyte while allowing lithium ion transport, thereby reducing interfacial side reactions, transition metal dissolution, electrolyte decomposition, gas evolution, resistive film formation, impedance growth, or capacity fade. The disclosed approaches also support scalable and controllable manufacturing, including solution-based deposition of cobalt-manganese oxide materials on stainless steel substrates and solvent-free resonant acoustic mixing of oxide particles with cathode active material particles. These features can improve electrochemical device reliability, extend useful operating life, reduce processing complexity, reduce solvent use, and support manufacture of electrochemical components for high-temperature solid oxide cells and lithium ion battery cells.

Before introducing the technology in detail, some context is provided.

As used herein, “electrochemical device” refers to an apparatus in which electrochemical reactions, ion transport, electron transport, and/or electrochemical interfaces are present during operation. Examples of electrochemical devices include solid oxide cells, solid oxide fuel cells, solid oxide electrolyzer cells, lithium ion batteries, fuel cells, electrolyzers, and electrochemical reactors.

As used herein, “electrochemical cell” refers to a cell or cell unit of an electrochemical device and includes an anode, a cathode, and an electrolyte in electrical communication with each of the anode and the cathode. In some embodiments, the electrochemical cell is a solid oxide cell. In some embodiments, the electrochemical cell is a lithium ion battery cell.

As used herein, “electrochemical component” refers to a material, article, particle, layer, substrate, current-conducting element, interconnect, electrode material, or other structure for use in an electrochemical device. The electrochemical component can be specifically designed and/or configured for use in the electrochemical device. Examples of electrochemical components include stainless steel interconnects, stainless steel gas manifold components, stainless steel compression plates, stainless steel current collectors, stainless steel sealing structures, lithium cathode active material particles, cathode active layers, and current collectors.

As used herein, “substrate” refers to a surface, body, particle, or plurality of particles on which a protective surface region can be disposed or formed. In some embodiments, the substrate is a stainless steel substrate. In some embodiments, the substrate is a plurality of lithium cathode active material particles. The substrate can be selected based on the operating environment of the electrochemical device, the degradation mechanism to be inhibited, and the compatibility of the substrate with the protective surface region.

As used herein, “protective surface region” refers to a coating, layer, surface treatment, particle coating, oxide-containing region, or modified surface region disposed on or formed at a surface of an electrochemical component to inhibit at least one degradation mechanism during operation of an electrochemical device. The protective surface region can be continuous or discontinuous, dense or porous, crystalline or amorphous, and can include metal oxide particles, a mixed-metal oxide, a spinel layer, nanometer sized oxide particles, or combinations thereof.

As used herein, “porous layer” refers to a layer having pores, voids, interparticle spaces, or gas-accessible or liquid-accessible pathways within or between particles of the layer. The porous layer can be formed from metal oxide particles. The porous layer can be specifically designed and/or configured to reduce chromium evaporation, reduce stainless steel oxidation, reduce interfacial reactions, and/or allow ion transport while limiting direct contact between a reactive component surface and a surrounding operating environment.

As used herein, “metal oxide particles” refers to particles that include one or more metal elements bonded with oxygen. Examples of metal oxide particles include cobalt manganese oxide particles, gamma alumina particles, titania particles, zirconia particles, silica particles, tungsten oxide particles, and combinations thereof. The metal oxide particles can be selected based on chemical stability, thermal stability, electrical conductivity, ionic transport properties, surface passivation capability, compatibility with the substrate, or compatibility with an electrochemical operating environment.

As used herein, “degradation mechanism” refers to a physical, chemical, electrochemical, or thermally induced process that reduces performance, durability, conductivity, structural integrity, or cycle life of an electrochemical component or electrochemical device. Examples of degradation mechanisms include chromium evaporation, stainless steel oxidation, interfacial side reaction, transition metal dissolution, electrolyte decomposition, gas evolution, corrosion, surface reconstruction, formation of resistive films, and combinations thereof.

As used herein, the term “degradation retardant” generally refers to materials, such as those disclosed herein, that at least partially reduce the degradation of an electrochemical component or electrochemical device, particularly at a surface of the electrochemical component or electrochemical device. An example of a degradation retardant is a metal oxide, e.g., in the form of metal oxide particles.

As used herein, “chromium evaporation” refers to formation, volatilization, transport, or release of chromium-containing species from a chromium-containing stainless steel component during operation of an electrochemical device. Chromium evaporation can occur at elevated temperatures in oxidizing or humid environments and can contaminate electrodes or other cell components.

As used herein, “stainless steel oxidation” refers to oxidation, scale growth, corrosion, or other oxygen-containing reaction products formed at or near a stainless steel surface during operation or heat treatment. Stainless steel oxidation can include formation of chromium oxide, iron oxide, manganese oxide, or mixed oxide phases.

As used herein, “interfacial side reaction” refers to an undesired reaction occurring at an interface between an electrochemical component and another material, including an interface between a cathode active material particle and an electrolyte or an interface between a stainless steel component and a gas atmosphere. Interfacial side reactions can contribute to impedance growth, capacity fade, gas generation, corrosion, or loss of active material. As used herein, “transition metal dissolution” refers to dissolution, leaching, migration, or loss of transition metal ions from an active electrode material. In some embodiments, transition metal dissolution includes dissolution of nickel, manganese, cobalt, or combinations thereof from lithium cathode active material particles.

As used herein, “electrolyte decomposition” refers to chemical or electrochemical breakdown of an electrolyte or an electrolyte component during operation of an electrochemical cell. Electrolyte decomposition can form gaseous species, resistive surface films, soluble by-products, or other reaction products that reduce electrochemical performance.

As used herein, “gas evolution” refers to generation or release of gaseous species during operation, storage, cycling, heating, or electrochemical reaction of an electrochemical device. Gas evolution can result from electrolyte decomposition, interfacial side reactions, corrosion, oxidation, or other degradation mechanisms.

As used herein, “stainless steel” refers to an iron-based alloy containing chromium and optionally including additional alloying elements. In some embodiments, the stainless steel is a ferritic stainless steel. Examples of stainless steel materials include Crofer 22 APU and AISI Type 441 stainless steel.

As used herein, “interconnect” refers to an electrically conductive component that electrically connects adjacent electrochemical cells or cell regions while maintaining separation between reactant streams or operating environments. In some embodiments, an interconnect is a stainless steel interconnect of a solid oxide cell stack.

As used herein, “solid oxide cell” refers to a high-temperature electrochemical cell that includes a solid oxide electrolyte. The solid oxide cell can be operated as a solid oxide fuel cell to generate electrical power or as a solid oxide electrolyzer cell to produce chemical products using electrical power.

As used herein, “oxide of cobalt and manganese” refers to an oxide material including cobalt, manganese, and oxygen. In some embodiments, the oxide of cobalt and manganese has the formula (Co,Mn)Ox, where x is 1 to 2. In some embodiments, x is 1.33 to 1.9. In some embodiments, cobalt and manganese are present in a stoichiometric molar ratio of 0.1:0.9 to 0.9:0.1.

As used herein, “spinel layer” refers to an oxide-containing layer having a spinel crystal structure or spinel-type mixed-metal oxide phase. In some embodiments, the spinel layer includes cobalt and manganese and can be formed by heat treating an amorphous cobalt manganese oxide layer on stainless steel.

As used herein, “stoichiometric molar ratio” refers to a molar ratio of constituent elements or precursor species selected to provide a desired relative amount of the elements in a material or coating. A stoichiometric molar ratio of cobalt to manganese refers to the molar amount of cobalt relative to the molar amount of manganese.

As used herein, “suspension” refers to a liquid composition containing particles distributed in a liquid medium. In some embodiments, the particles in the suspension are sufficiently small so that the particles do not substantially scatter visible light. The suspension can include dissolved salts, reaction products, or particles formed by reaction of a cobalt salt with a manganese-containing salt.

As used herein, “slurry” refers to a liquid composition containing particles distributed in a liquid medium at a concentration or particle size suitable for coating a substrate. In some embodiments, the particles in the slurry are larger than particles in a suspension and can precipitate under quiescent conditions.

As used herein, “micron sized lithium cathode active material particles” or “micrometer sized lithium cathode active material particles” refers to lithium-containing cathode active material particles having an average particle size in the micrometer range. In some embodiments, the micrometer sized lithium cathode active material particles have an average particle size of 5 micrometers to 40 micrometers.

As used herein, “nickel manganese cobalt oxide” or “NMC” refers to a lithium nickel manganese cobalt oxide cathode active material. In some embodiments, NMC has a formula LiNiₓMn_{y}Co_{z}O₂, where x + y + z is about 1. Examples of NMC include NMC111, NMC532, NMC622, and NMC811.

As used herein, “nickel cobalt aluminum oxide” or “NCA” refers to a lithium nickel cobalt aluminum oxide cathode active material.

As used herein, “lithium cobalt oxide” or “LCO” refers to a lithium cobalt oxide cathode active material.

As used herein, “nanometer sized oxide particles” refers to oxide particles having an average particle size in the nanometer range. In some embodiments, the nanometer sized oxide particles have an average particle size of 2 nanometers to 30 nanometers. Examples of nanometer sized oxide particles include gamma alumina particles, titania particles, zirconia particles, silica particles, tungsten oxide particles, and combinations thereof.

As used herein, “gamma alumina” or “γ-Al₂O₃” refers to a gamma-phase aluminum oxide material. In some embodiments, gamma alumina is provided as nanometer sized particles disposed on surfaces of NMC particles to form an NMC-γ-Al₂O₃ mixture.

As used herein, “resonant acoustic mixing” refers to mixing using mechanically induced resonant-frequency vibrations applied to a mixing vessel to mobilize and mix materials in the vessel without internal impellers. In some embodiments, resonant acoustic mixing is conducted at 40 times the force of gravity to 110 times the force of gravity and at a frequency of 50 hertz to 100 hertz. Resonant acoustic mixing can be conducted in the absence of a solvent to dispose nanometer sized oxide particles on micrometer sized lithium cathode active material particles.

As used herein, “in the absence of a solvent” refers to a process in which no solvent is intentionally added to the materials being processed. In some embodiments, resonant acoustic mixing of NMC particles and gamma alumina particles is performed in the absence of a solvent.

As used herein, “cathode active material” refers to a material that participates in lithium insertion, lithium extraction, or other electrochemical cathode reactions during operation of a lithium ion battery cell. In some embodiments, the cathode active material includes an NMC-γ-Al₂O₃ mixture.

As used herein, “cathode active layer” refers to a layer disposed on a current collector and including cathode active material. In some embodiments, the cathode active layer includes a surface-protected cathode mixture, an electrically conductive filler, and a polymer binder.

As used herein, “electrically conductive filler” refers to a conductive additive used to increase electronic conductivity of an electrode layer. Examples of electrically conductive fillers include carbon black, carbon nanotubes, graphite, graphene, and combinations thereof. As used herein, “poly(vinylidene difluoride)” or “PVDF” refers to a fluoropolymer binder that can bind particles in a cathode active layer.

As used herein, “N-methyl-2-pyrrolidone” or “NMP” refers to an organic solvent that can be used to form a slurry including cathode active material, electrically conductive filler, and PVDF.

As used herein, “current collector” refers to an electrically conductive substrate specifically designed and/or configured to collect or distribute electrons to or from an electrode layer. In some embodiments, the current collector is an aluminum foil supporting a cathode active layer. In some embodiments, the current collector is a stainless steel component of a solid oxide cell.

### Surface Electrochemical Components for Electrochemical Cells

In one aspect, the present disclosure provides an electrochemical component of an electrochemical cell, the electrochemical component including a substrate forming at least a portion of an electrochemical component; and a protective surface region disposed on the electrochemical component. The protective surface region generally includes at least one degradation retardant. The degradation retardant can be a porous layer of metal oxide particles. The protected surface region can be an surface that has been treated with at least one degradation retardant such as metal oxides to inhibit a degradation mechanism of the electrochemical component during operation of an electrochemical device.

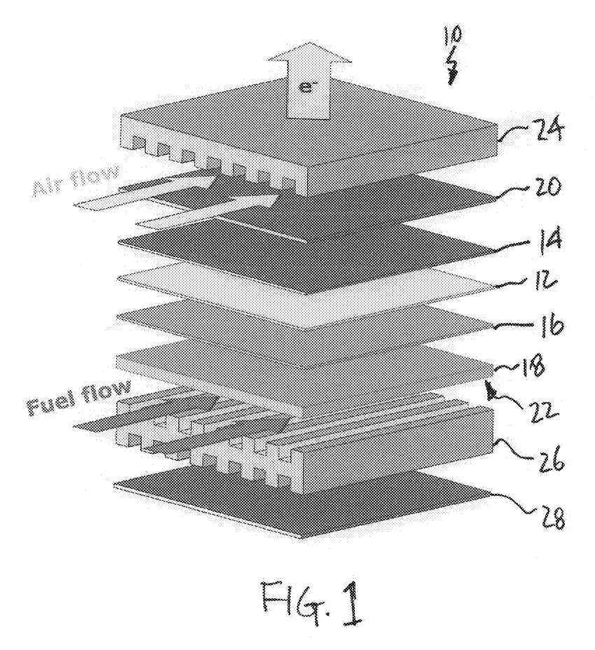

Stainless steel surfaces are sometimes utilized within a solid oxide fuel cell (SOFC) stack as structural and functional components due to their high-temperature stability, mechanical strength, and electrical conductivity. Referring to FIG. 1, a schematic of some embodiments of a solid oxide fuel cell stack 10 is depicted. The solid oxide fuel cell stack 10 includes an electrolyte 12 positioned between a cathode 14 and an anode 16. The cathode 14 is positioned adjacent to a cathode current collector 20, and the anode 16 is positioned adjacent to an anode support 18. The anode support 18 is positioned adjacent to an anode current collector 22. A cathode interconnect 24 is positioned on a side of the cathode current collector 20 opposite the cathode 14, and an anode interconnect 26 is positioned on a side of the anode current collector 22 opposite the anode support 18. A portion of housing 28 can be positioned adjacent to the anode interconnect 26.

In the embodiment depicted in FIG. 1, air flow is directed along the cathode side of the solid oxide fuel cell stack 10, and fuel flow is directed along the anode side of the solid oxide fuel cell stack 10. The cathode interconnect 24 and the anode interconnect 26 can be stainless steel interconnects used to electrically connect neighboring cells of a solid oxide stack while maintaining separation between fuel and oxidant gas streams. The cathode interconnect 24 and the anode interconnect 26 can include stainless steel surfaces on which a coating for stainless steel is disposed, the coating comprising an oxide of cobalt and manganese. In some embodiments, the oxide of cobalt and manganese has the formula (Co,Mn)Ox, where x is 1 to 2, and the cobalt and manganese are present in a stoichiometric molar ratio of 0.1:0.9 to 0.9:0.1. The coating can slow down stainless steel oxidation at elevated temperatures and can trap volatile species from the stainless steel while remaining electrically conductive at high temperatures.

More specifically, ferritic stainless steels comprising chromium, such as Crofer 22 APU or AISI Type 441 stainless steel, are employed as metallic interconnects positioned between adjacent electrochemical cells. These interconnects serve to electrically connect individual cells in series while maintaining separation between the fuel and oxidant gas streams. The stainless steel interconnects can include flow channels to facilitate the uniform distribution of reactant gases and are configured to provide structural support across the cell stack. In addition to interconnects, stainless steel components can be used in gas manifolds, compression plates, current collectors, and sealing structures to ensure mechanical integrity and gas-tight operation under elevated temperatures, typically in the range of 600° C. to 1000° C. To mitigate high-temperature degradation mechanisms, such as chromium evaporation, a porous metal oxide coating can be formed on the stainless steel surface.

In some embodiments, the process used to apply the protective coating can produce a protective layer of various thickness. For example, if the protective layer is formed by dip coating, the resulting protective layer is generally a thicker protective layer. A thicker protective layer can prevent the chromium migration via the gas phase. If the protective layer is formed by spraying, the resulting protective layer may be regarded as a thinner protective layer. A thinner layer can reduce the thermal resistance (i.e., increase heat transfer) of the protective layer thereby improving stack performance.

In some embodiments, the protective coating comprises a coating for stainless steel, where the coating comprises an oxide of cobalt and manganese (Co,Mn)Oₓ, where x is 1 to 2. In some embodiments, x is 1 to 2, 1.1 to 2, 1.2 to 2, 1.3 to 2, 1.4 to 2, 1.5 to 2, 1.6 to 2, 1.7 to 2, 1.8 to 2, 1.9 to 2, 1 to 1.9, 1 to 1.8, 1 to 1.7, 1 to 1.6, 1 to 1.5, 1 to 1.4, 1 to 1.3, 1 to 1.2, or 1 to 1.1. In certain embodiments, x is 1.33 to 1.9.

The cobalt and manganese can be present in a stoichiometric molar ratio of 0.1:0.9 to 0.9:0.1. In some embodiments, a stoichiometric molar ratio of cobalt to manganese is 0.1:0.9 to 0.9:0.1, 0.1:0.9 to 0.8:0.2, 0.1:0.9 to 0.7:0.3, 0.1:0.9 to 0.6:0.4, 0.1:0.9 to 0.5:0.5, 0.1:0.9 to 0.4:0.6, 0.1:0.9 to 0.3:0.7, 0.1:0.9 to 0.2:0.8, 0.2:0.8 to 0.9:0.1, 0.3:0.7 to 0.9:0.1, 0.4:0.6 to 0.9:0.1, 0.5:0.5 to 0.9:0.1, 0.6:0.4 to 0.9:0.1, 0.7:0.3 to 0.9:0.1, or 0.8:0.2 to 0.9:0.1.

The protective coating can have a thickness of 5 to 20 micrometers, for example, when dip coated. This is referred to herein as a “thick coating.” In some embodiments, the protective surface region has a thickness of 5 to 20 micrometers, 5 to 18 micrometers, 5 to 16 micrometers, 5 to 14 micrometers, 5 to 12 micrometers, 5 to 10 micrometers, 5 to 8 micrometers, 5 to 6 micrometers, 7 to 20 micrometers, 9 to 20 micrometers, 11 to 20 micrometers, 13 to 20 micrometers, 15 to 20 micrometers, 17 to 20 micrometers, or 19 to 20 micrometers. In certain embodiments, the protective thick coating can have a thickness of 0.1 to 0.5 micrometers.

The protective coating can have a thickness of 0.1 to less than 5 micrometers, for example, when spray coated. This is referred to herein as a “thin coating.” In some embodiments, the protective surface region has a thickness of 0.1 to 4 micrometers, 0.1 to 3 micrometers, 0.1 to 2 micrometers, 0.1 to 1 micrometers, 0.1 to 0.9 micrometers, 0.1 to 0.7 micrometers， 0.1 to 0.5 micrometers 0.1 to 0.3 micrometers, 0.3 to 4 micrometers, 0.5 to 4 micrometers, 0.7 to 4 micrometers, 0.7 to 4 micrometers, 0.9 to 4 micrometers, 1 to 4 micrometers, 2 to 4 micrometers, or 3 to 4 micrometers. In certain embodiments, the protective thin coating can have a thickness of 0.1 to 0.5 micrometers.

The protective coating and its method of manufacture thereof are exemplified by the non-limiting examples, specifically, Examples 1 and 2.

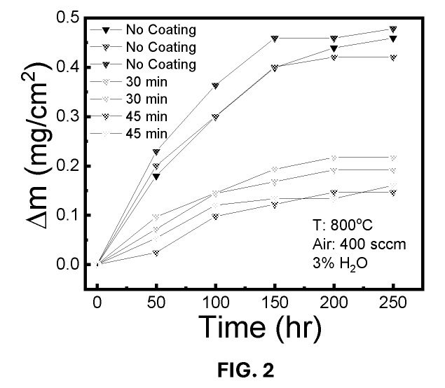

In particular, FIG. 2 is a graph that depicts the effect of coating time on the oxidation behavior of stainless steel. In FIG. 2, change in mass per unit area, Δm, in milligrams per square centimeter is plotted as a function of time in hours for stainless steel samples with no coating and for stainless steel samples coated for 30 minutes and 45 minutes. The samples represented in FIG. 2 were evaluated at T: 800° C. in air supplied at 400 sccm with 3% H₂O. As shown in FIG. 2, the coated stainless steel samples exhibit a lower Δm over time than the stainless steel samples with no coating, indicating reduced oxidation behavior under the illustrated test conditions.

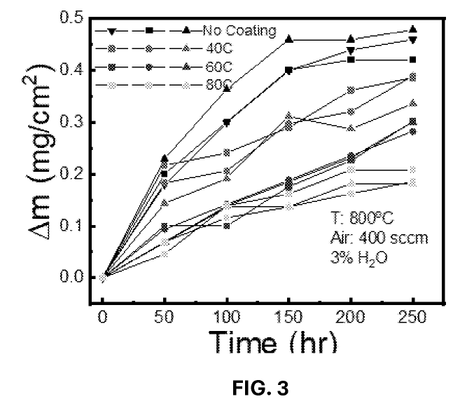

FIG. 3 is a graph that depicts the effect of coating temperature on the oxidation behavior of stainless steel. In FIG. 3, Δm in milligrams per square centimeter is plotted as a function of time in hours for stainless steel samples with no coating and for stainless steel samples coated at 40° C. , 60° C. , and 80° C. The samples represented in FIG. 3 were evaluated at T: 800° C. in air supplied at 400 sccm with 3% H₂O. As shown in FIG. 3, coating temperature affects the measured oxidation behavior of the coated stainless steel samples relative to the stainless steel samples with no coating.

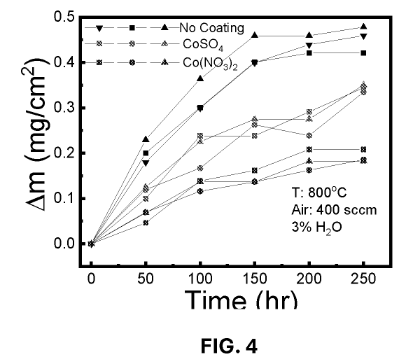

FIG. 4 is a graph that depicts the effect of cobalt salt on the oxidation behavior of stainless steel. In FIG. 4, Δm in milligrams per square centimeter is plotted as a function of time in hours for stainless steel samples with no coating and for stainless steel samples coated using CoSO₄ and Co(NO3)2. The samples represented in FIG. 4 were evaluated at T: 800° C. in air supplied at 400 sccm with 3% H₂O. As shown in FIG. 4, the cobalt salt used in the aqueous solution affects the oxidation behavior of the coated stainless steel samples.

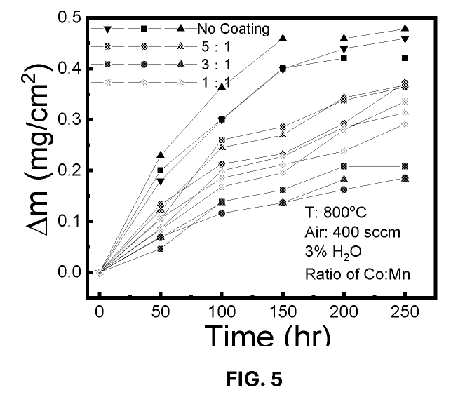

FIG. 5 is a graph that depicts the effect of Co:Mn ratio in the coating solution on the oxidation behavior of stainless steel. In FIG. 5, Δm in milligrams per square centimeter is plotted as a function of time in hours for stainless steel samples with no coating and for stainless steel samples coated using Co:Mn ratios of 5:1, 3:1, and 1:1 in the coating solution. The samples represented in FIG. 5 were evaluated at T: 800° C. in air supplied at 400 sccm with 3% H₂O. As shown in FIG. 5, the Co:Mn ratio in the coating solution affects the oxidation behavior of the coated stainless steel samples.

Also specifically disclosed herein are particles of a NMC (nickel manganese cobalt oxides; commonly referred to as NMCs) cathode material coated with particles of gamma-alumina (γ-Al₂O₃). The coating takes place in the absence of a solvent. The γ-Al₂O₃ coating facilitates the prevention of side reactions in the NMC cathode material during cycling, thus significantly improving the cycle performance of the NMC cathode materials.

The γ-Al₂O₃ particles are nanometer sized particles and coat the surface of the micrometer sized nickel manganese cobalt oxide particles to form a NMC-γ-Al₂O₃ mixture. The NMC-γ-Al₂O₃ mixture can then be molded to form a cathode active material layer.

While this disclosure is focused on the NMC-γ-Al₂O₃,the particles can contain compositions comprising NMC-oxidemixtures comprising nanometer sized oxideparticles (γ-Al₂O₃, TiO_{2,} ZrO₂, SiO₂ and WO₃) disposed on micrometer sized cathode particles (NMC, nickel cobalt aluminum oxide (NCA), lithium cobalt oxide (LCO)).

Nickel-manganese-cobalt oxides are a class of layered transition metal oxide compounds that can be used as cathode materials in lithium ion batteries due to their high energy density, thermal stability, and favorable electrochemical performance. These materials are generally represented by the formula LiNiₓMn_{y}Co_{z}O₂, where x + y + z ≈ 1, and the relative proportions of nickel, manganese, and cobalt are varied to tailor specific performance attributes such as capacity, cycle life, and thermal characteristics. In some embodiments, the value of x (nickel content) is 0.2 to 0.9, such as 0.2 to 0.8. Nickel enhances specific capacity due to its redox activity. The value of y (manganese content) is 0.05 to 0.6, such as 0.1 to 0.5. In some embodiments, manganese provides structural stability and thermal robustness. The value of z (cobalt content) is 0.05 to 0.4, such as 0.1 to 0.35. The cobalt can contribute to electronic conductivity and facilitates the formation of a layered structure.

In some embodiments, NMC compositions include NMC111 (LiNi₁/₃Mn₁/₃Co₁/₃O₂), NMC532, NMC622, and NMC811, which indicate increasing nickel content to boost capacity and reduce reliance on cobalt. Numerous modifications and derivatives of NMC materials are possible to improve structural integrity, rate capability, and safety, including surface coatings, doping with additional metal ions, and core-shell architectures. These compositional and structural variations enable NMC-based cathodes to be optimized for diverse applications, ranging from consumer electronics to electric vehicles and grid-scale energy storage.

The NMC particles have a particle size of 5 to 40 micrometers. In some embodiments, the NMC particles have an average particle size of 5 to 40 micrometers, 5 to 35 micrometers, 5 to 30 micrometers, 5 to 25 micrometers, 5 to 20 micrometers, 5 to 15 micrometers, 5 to 10 micrometers, 10 to 40 micrometers, 15 to 40 micrometers, 20 to 40 micrometers, 25 to 40 micrometers, 30 to 40 micrometers, or 35 to 40 micrometers.

The NMC particles are present in an amount of 95 to 99.5 weight percent (wt%), based on a total weight of the NMC- γ-Al₂O₃ mixture. In some embodiments, the NMC particles are present in an amount of 95 to 99.5 weight percent (wt%), 95 to 99 wt%, 95 to 98 wt%, 95 to 97 wt%, 95 to 96 wt%, 96 to 99.5 wt%, 97 to 99.5 wt%, 98 to 99.5 wt%, or 99 to 99.5 wt%.

Gamma alumina (γ-Al₂O₃) is used as a surface coating on nickel-manganese-cobalt oxide (NMC) particles in lithium ion batteries to enhance electrochemical performance and extend material longevity. The application of a γ-alumina coating provides a chemically inert and thermally stable barrier layer that mitigates undesirable surface reactions between the active cathode material and the liquid electrolyte, particularly at elevated voltages. Specifically, γ-Al₂O₃ suppresses the formation of resistive surface films on the NMC particles, inhibits transition metal dissolution (especially of nickel and manganese), and reduces electrolyte decomposition and gas evolution.

Additionally, the porous and high-surface-area nature of γ-alumina allows for lithium ion transport while preventing direct contact between the electrolyte and reactive cathode surfaces. This surface passivation improves the structural stability of NMC particles during repeated charge-discharge cycles, leading to improved cycle life, thermal stability, and rate capability, especially in high-nickel content compositions such as NMC622 and NMC811, which are more prone to degradation without protective coatings.

The γ-Al₂O₃ particles have a particle size of 2 to 30 nanometers, 5 to 15 nanometers, or 8 to 13 nanometers. In some embodiments, the nanometer-sized oxide particles have an average particle size of 2 to 30 nanometers, 2 to 27 nanometers, 2 to 24 nanometers, 2 to 21 nanometers, 2 to 18 nanometers, 2 to 15 nanometers, 2 to 12 nanometers, 2 to 9 nanometers, 2 to 6 nanometers, 5 to 30 nanometers, 8 to 30 nanometers, 11 to 30 nanometers, 14 to 30 nanometers, 17 to 30 nanometers, 20 to 30 nanometers, 23 to 30 nanometers, or 26 to 30 nanometers.

The γ-Al₂O₃ particles are present in an amount of 0.5 to 5 weight percent (wt%), based on a total weight of the NMC-γ-Al₂O₃ mixture. In some embodiments, the γ-Al₂O₃ particles are present in an amount of 0.5 to 5 weight percent (wt%), 0.5 to 4.5 wt%, 0.5 to 4 wt%, 0.5 to 3.5 wt%, 0.5 to 3 wt%, 0.5 to 2.5 wt%, 0.5 to 2 wt%, 0.5 to 1.5 wt%, 0.5 to 1 wt%, 1 to 5 wt%, 1.5 to 5 wt%, 2 to 5 wt%, 2.5 to 5 wt%, 3 to 5 wt%, 3.5 to 5 wt%, 4 to 5 wt%, or 4.5 to 5 wt%.

The NMC-γ-Al₂O₃ mixture can then be converted into a cathode active material by mixing the NMC-γ-Al₂O₃ particles with an electrically conductive filler, a polymer and an organic solvent. The cathode active material can be then molded into a cathode active layer that can be disposed on a cathode current collector to form the cathode in a lithium ion battery, a fuel cell or in an electrochemical reactor.

In some embodiments, the NMC-γ-Al₂O₃ mixture is used in an amount of 70 to 90 wt%, based on a total weight of the cathode active material. In some embodiments, the cathode active material includes cathode active material in an amount of 70 to 90 wt%, 70 to 85 wt%, 70 to 80 wt%, 70 to 75 wt%, 75 to 90 wt%, 80 to 90 wt%, or 85 to 90 wt%.

Electrically conducting fillers include carbon black, carbon nanotubes, graphite, graphene, or a combination thereof. The electrically conducting fillers are used in an amount of 5 to 15 wt%, based on a total weight of the cathode active material. In some embodiments, the electrically conducting fillers are used in an amount of 5 to 15 wt%, 5 to 13 wt%, 5 to 11 wt%, 5 to 9 wt%, 5 to 7 wt%, 7 to 15 wt%, 9 to 15 wt%, 11 to 15 wt%, or 13 to 15 wt%, based on a total weight of the cathode active material.

The polymer used in the cathode active material can be poly(vinylidene difluoride) (PVDF). The PVDF used in an amount of 5 to 15 wt%, based on a total weight of the cathode active material. In some embodiments, the PVDF used in an amount of 5 to 15 wt%, 5 to 13 wt%, 5 to 11 wt%, 5 to 9 wt%, 5 to 7 wt%, 7 to 15 wt%, 9 to 15 wt%, 11 to 15 wt%, or 13 to 15 wt%.

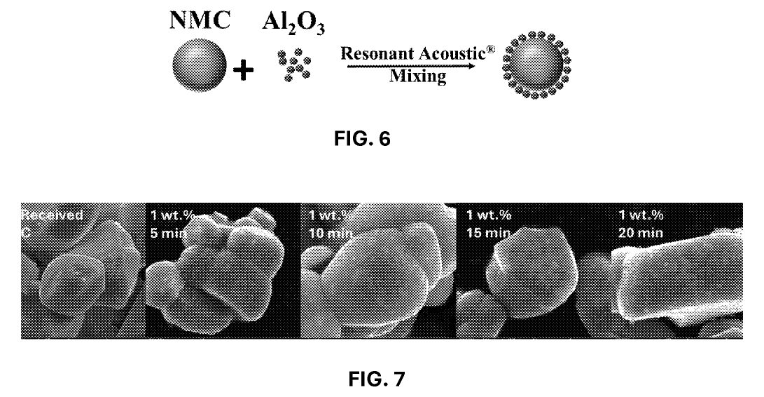

Referring to FIG. 6, a schematic diagram depicts the mixing of nickel manganese cobalt oxide particles, also referred to as NMC particles, with gamma alumina particles, also referred to as γ-Al₂O₃ particles, to form a coating of the γ-Al₂O₃ particles on the NMC particles. In some embodiments, the NMC particles are micrometer sized lithium cathode active material particles and the γ-Al₂O₃ particles are nanometer sized oxide particles. The NMC particles and the γ-Al₂O₃ particles can be placed in a mixing vessel and subjected to resonant acoustic mixing. The resonant acoustic mixing applies acoustic energy to the mixing vessel to mobilize the particles and dispose the γ-Al₂O₃ particles on surfaces of the NMC particles. The resulting NMC-γ-Al₂O₃ mixture includes γ-Al₂O₃ particles distributed on the surfaces of the NMC particles to provide a surface-protected cathode mixture.

In some embodiments, the resonant acoustic mixing depicted schematically in FIG. 6 can be performed in the absence of a solvent. In some embodiments, the resonant acoustic mixing is conducted for 1 minute to 50 minutes at 40 times the force of gravity to 110 times the force of gravity. In some embodiments, the resonant acoustic mixing is conducted at 70 times the force of gravity to 100 times the force of gravity for 4 minutes to 10 minutes. In one example, fumed nano γ-Al₂O₃ particles having an average particle size of about 10 nanometers and NMC particles having an average particle size of about 13 micrometers are added to a mixing jar and processed using resonant acoustic mixing at about 90 times the force of gravity for about 5 minutes to form the NMC-γ-Al₂O₃ mixture. The NMC-γ-Al₂O₃ mixture can be used directly after the resonant acoustic mixing to form a cathode active material.

FIG. 7 depicts a series of scanning electron micrographs that show γ-Al₂O₃ particles disposed on NMC particles when subjected to mixing for different time periods. The scanning electron micrographs show that the γ-Al₂O₃ particles are present on outer surfaces of the NMC particles after resonant acoustic mixing. The different time periods illustrate that mixing time affects the distribution of the γ-Al₂O₃ particles on the NMC particles. In some embodiments, increasing or selecting the mixing time can be used to adjust the extent of coverage of the γ-Al₂O₃ particles on the NMC particles while maintaining the NMC particles as micrometer sized cathode active material particles.

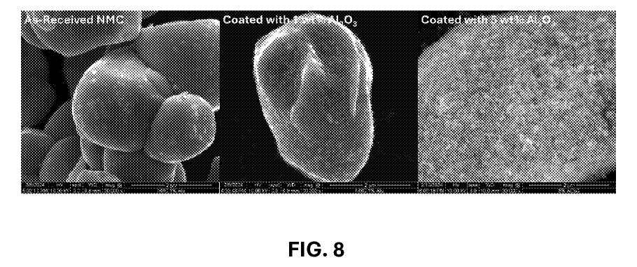

FIG. 8 depicts a series of scanning electron micrographs that show different amounts of γ-Al₂O₃ particles disposed on NMC particles. In the embodiment depicted in FIG. 8, the scanning electron micrographs include an as-received NMC sample, an NMC sample coated with 1 weight percent γ-Al₂O₃ particles, and an NMC sample coated with 5 weight percent γ-Al₂O₃ particles. The scanning electron micrographs show that the amount of γ-Al₂O₃ particles affects the surface coverage of the NMC particles. In some embodiments, the γ-Al₂O₃ particles are present in an amount of 0.5 weight percent to 5 weight percent, based on a total weight of the NMC-γ-Al₂O₃ mixture. In some embodiments, the γ-Al₂O₃ particles have an average particle size of 2 nanometers to 30 nanometers, 5 nanometers to 15 nanometers, or 8 nanometers to 13 nanometers. The γ-Al₂O₃ particles provide a surface coating that can reduce direct contact between the NMC particles and electrolyte during operation of a lithium ion battery cell.

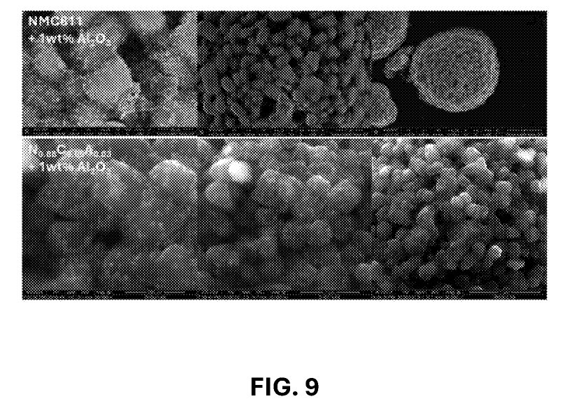

FIG. 9 depicts scanning electron micrographs of cathode active material particles coated with 1 weight percent Al₂O₃. The upper row of micrographs depicts NMC811 particles coated with 1 weight percent Al₂O₃, and the lower row of micrographs depicts N0.88C0.09A0.03 particles coated with 1 weight percent Al₂O₃. As shown in FIG. 9, Al₂O₃ particles are disposed on outer surfaces of the cathode active material particles after mixing. The micrographs show that the Al₂O₃ particles can be distributed over different lithium cathode active material chemistries, including nickel manganese cobalt oxide particles and nickel cobalt aluminum oxide particles. In some embodiments, the Al₂O₃ particles are nanometer sized oxide particles that form a protective surface region on micrometer sized cathode active material particles to reduce direct contact between the cathode active material particles and an electrolyte during operation of a lithium ion battery cell.

### Methods of Making Oxide Based Protected Surface Electrochemical Components

In another aspect, referring to FIG. 1, the present disclosure provides a layer or a coating on the cathode interconnect 24 or the anode interconnect 26 that can be formed by a method disclosed herein. The method can include dissolving a cobalt salt in an aqueous solution and dissolving a salt comprising potassium and manganese in the aqueous solution. The solution can be sprayed or screen printed on the metal substrate to form a thin coating, or the metal substrate can be dip coated with the solution to form a thick coating. The thin coating or the thick coating can be dried to remove the aqueous solution and reaction by-products, and can be calcined at a temperature of 600 to 1000° C. to form a spinel layer on the surface. Electron flow through the solid oxide fuel cell stack 10 is schematically indicated in FIG. 1.

More specifically, the method comprises forming a protective layer via screen printing or by spraying an ink slurry that comprises an organic solvent and metal oxide particles. This leads to the formation of a thick porous protective layer on the stainless teel surface which reduces or prevents chromium evaporation.

The method comprises mixing a cobalt salt with a manganese salt in an aqueous solution until both salts are dissolved to form a suspension or a slurry. Alternatively, the salts can be dissolved sequentially with either salt being dissolved first followed by a second salt. The salts are added in a desired stoichiometric ratio. The Co/Mn molar ratio = 1 to 7. The amounts of the respective salts determines whether a suspension is formed or whether a salt is formed. A suspension involves particle formation of a size that do not scatter light - in other words the particles that are suspended in the solution are of a size smaller than the size of the wavelength of light. In a slurry, the particles are larger than the minimum size for precipitation and therefore undergo precipitation to form a slurry.

In some embodiments, the suspension or the slurry is then disposed on a metal substrate that it is desired to coat. The metal substrate may be a stainless steel interconnect that can be used to connect neighboring cells of a solid oxide stack. These metal substrates may be either screen coated, spray coated or dip coated depending upon the type of coating desired. If a thick, dense coating is desired, then it can be dip coated in a slurry. If a thin, porous coating is desired, then spray coating or screen printing can be used with the coating solution being in the form of a suspension.

In some embodiments, the first salt includes a salt of cobalt nitrate (Co(NO₃)₂·6H₂O), cobalt sulfate (CoSO₄·7H₂O), cobalt chloride (CoCl₂·6H₂O), cobalt acetate (Co(CH₃COO)₂·4H₂O), cobalt oxalate (CoC₂O₄·2H₂O), cobalt carbonate (CoCO₃), cobalt phosphate (Co₃(PO₄)₂·8H₂O), or a combination thereof. These cobalt salts can be used in aqueous or non-aqueous solutions, depending on the processing method, and can serve as sources of Co²⁺ or Co³⁺ ions for incorporation into oxide matrices, spinel structures, or mixed-metal systems. The specific choice of cobalt salt can be selected based on solubility, reactivity, decomposition behavior, and compatibility with co-precipitation, sol-gel synthesis, or other deposition techniques used to form the final electrochemically active or protective material.

The first salt can be added to the aqueous solution in an amount of 2 to 8 wt%, based on a total weight of the aqueous solution. The total weight of the aqueous solution includes the sum of the weight of the first salt, the second solvent and that of the aqueous solvent.

In some embodiments, the second salt can comprise potassium permanganate (KMnO₄), a strong oxidizing agent. Potassium permanganate can serve as a source of manganese ions and can facilitate the oxidative transformation of precursor materials, promote the formation of mixed-metal oxides, or introduce desired oxidation states into the final composition. KMnO₄can be employed in aqueous or non-aqueous media, and can be introduced during co-precipitation, impregnation, or thermal decomposition processes. Its use can enable the incorporation of manganese into spinel, perovskite, or layered oxide frameworks, and can enhance the redox activity, structural stability, or corrosion resistance of the resulting material when applied to components such as metallic interconnects, electrodes, or catalytic surfaces in high-temperature electrochemical systems.

The second salt can be added to the aqueous solution in an amount of 0.4 to 1 wt%, based on a total weight of the aqueous solution.

The reactants (the first salt, the second salt and the solvent) are mixed for a period of time of 5 minutes to 10 hours, such as 10 minutes to 1 hour.

After coating the metal substrates are washed with a second solvent (e.g., deionized water) to remove any undesirable residues and then dried in an over from 60 to 90°C for 2 to 15 hours. An amorphous layer of (Co,Mn)Oₓ forms on the surface.

In some embodiments, the total solids content in a suspension is 0.001 to 0.3 weight percent (wt%), based on the total weight of the salts and the aqueous solution in the suspension. In some embodiments, the total solids content in a slurry is 0.001 to 2 weight percent (wt%), based on the total weight of the salts and the aqueous solution in the slurry. The total solids is the weight of matter that does not evaporate after all the reactions are completed.

The metal substrates with the protective coating disposed can be then heat treated at 600^{o}C. to 1000° C. , such as 750 to 850° C. for 1 to 3 hours to form the spinel layer on the surface. The samples undergo oxidation process in a tube furnace, with 1 to 5% water humidified air at 800° C.

The weights of samples are measured every 50 hours to study the corrosion kinetics.

The heat treatment can involve calcining of annealing. Calcining refers to a high-temperature process, conducted in an oxidative atmosphere such as air, and can be primarily used to decompose metal salts, hydroxides, or carbonates into stable metal oxides by removing volatile components such as water or carbon dioxide. In contrast, annealing involves heating a material to a specified temperature, often under controlled atmospheres such as inert gas, air, or reducing environments, without inducing decomposition. Annealing can be used to modify the microstructure, relieve internal stresses, enhance crystallinity, or adjust the oxidation state of a material without altering its overall chemical composition. The selection between calcining and annealing can be determined by the nature of the starting material and the functional properties desired in the final product.

Also disclosed herein is a method of dry coating particles of a NMC (nickel manganese cobalt oxides) cathode material with particles of gamma-alumina (γ-Al₂O₃). The coating takes place in the absence of a solvent. The γ-Al₂O₃ coating facilitates the prevention of side reactions in the NMC cathode material during cycling, thus significantly improving the cycle performance of the NMC cathode materials.

The method includes using sound energy to coat nickel manganese cobalt oxide particles with an inactive material layer comprising γ-Al₂O₃ particles. The γ-Al₂O₃ particles are nanometer sized particles and coat the surface of the micrometer sized nickel manganese cobalt oxide particles to form a NMC-γ-Al₂O₃ mixture. The NMC-γ-Al₂O₃ mixture can then be molded to form a cathode active material layer.

While this disclosure is focused on the NMC-γ-Al₂O₃,the particles can contain compositions comprising NMC-oxidemixtures comprising nanometer sized oxideparticles (γ-Al₂O₃, TiO_{2,} ZrO₂, SiO₂ and WO₃) disposed on micrometer sized cathode particles (NMC, nickel cobalt aluminum oxide (NCA), lithium cobalt oxide (LCO)).

The dry coating of the cathode active layer with the γ-Al₂O₃ particles has a number of advantages. These include significantly reducing the processing time for manufacturing the electrode, significantly reducing the environmental footprint by eliminating the use of solvent and reducing the number of operating units used in the production of the electrodes (e.g., drying equipment, heating equipment, and the like). In addition, the method disclosed herein can be easily adapted into a continuous manufacturing process on an industrial scale.

In some embodiments, in one method of producing the NMC-γ-Al₂O₃ mixture, the NMC particles and the γ-Al₂O₃ particles are taken in a mixing vessel and subjected to a mixing process at 40 to 110 times the force of gravity (G), such as at 70 to 100G for 1 to 50 minutes, or 4 to 10 minutes. No additional annealing process, the coated cathode materials were used directly after treated. Examples of equipment suited for the mixing process include products employing ResonantAcoustic® Mixing (RAM) from Resodyn Acoustic Mixers, Inc. of Butte, MT.

Generally, ResonantAcoustic mixing (RAM) is a high-efficiency, low-shear mixing technology that employs mechanically induced, resonant-frequency vibrations to uniformly blend solid, liquid, or multiphase materials without the use of internal impellers or rotating components. In this technique, a mixing vessel is subjected to acoustic energy at frequencies of 50 to 100 Hz, such as at 60 Hz resulting in high-acceleration forces which often exceed 40 times the force of gravity (40G) and fluidize and mobilize the contents of the vessel. The absence of direct mechanical agitation reduces the risk of material degradation, contamination, or structural alteration, making RAM particularly advantageous for sensitive or reactive systems. That is, unlike high shear mixing, ball milling, mecha-fusion, high-speed mechanical mixing and other similar techniques, RAM can distribute nanometer oxide particles while reducing particle fracture, particle-size change, and morphology change.

The mixing process enables a homogeneous dispersion of powders and slurries and is suited for applications involving complex composites or particulate suspensions, such as in the formulation of battery electrode slurries and energetic materials. In some embodiments, the resonant acoustic mixing facilitates a uniform coating of the γ-Al₂O₃ particles on the NMC particles. The resonant acoustic mixing may be conducted in the absence of a fluid. It can be not necessary to use solvents or liquids during the resonant acoustic mixing.

The solvent used to mix the NMC-γ-Al₂O₃ mixture, the electrically conducting filler, the polymer and the solvent can be N-methyl-2-pyrrolidone (NMP). The solvent can be added to the mixture of NMC-γ-Al₂O₃ mixture, the electrically conducting filler and the polymer in an amount of 50 to 100 wt%, based on a total weight of the NMC-γ-Al₂O₃ mixture, the electrically conducting filler and the polymer (also called the cathode active material). The solvent, the NMC-γ-Al₂O₃ mixture, the electrically conducting filler and the polymer can be mixed to form a slurry. The slurry can be cast onto a cathode current collector (e.g., an aluminum foil) and dried in vacuum at a temperature of 80 to 140°C, such as 110 to 130°C for 2 to 20 hours, or 5 to 10 hours to form the cathode. The slurry upon drying form a layer of the cathode active material (called the cathode active layer).

The NMC-γ-Al₂O₃ mixture, the method of manufacture of the cathode active material and the cathode active layer are exemplified by the following non-limiting examples, specifically, Examples 3-6.

In addition, in some embodiments, a computer program product is provided. The computer program product can be stored on non-transitory machine readable media and include instructions for implementing methods. The methods can provide for control of equipment (such as that which is disclosed herein as well as a variety of other functionally related equivalents), communications, user-interaction, input and output, calculations and estimations, and other functions as set forth herein.

### Examples

### Example 1

This example was conducted to demonstrate the manufacturing of the coating and its deposition on steel plates (which are substitutes for stainless steel interconnects used in stacks of solid oxide reactors).

Stainless steel sheets were cut into stripes and sonicated in deionized (DI) water, ethanol, and 10% hydrogen peroxide (H₂O₂) solution for 15 minutes, respectively in order to surface clean them. Surface cleaning the substrate improves adhesion to the protective coating.

A cobalt precursor solution was first prepared by mixing cobalt salt and de-ionized water in a beaker. The beaker was placed in a water bath for 15 minutes to reach a uniform temperature. The cobalt salt can be cobalt (II) nitrate, cobalt (II) sulfate, cobalt (II) acetates, or a combination thereof. The concentration of cobalt precursor and coating temperature affect the coating thickness and morphology of the protective layer coating.

KMnO₄ was added into the cobalt precursor solution in a specific molar ratio. The clean stainless steel strip was dipped vertically into the reactive solution. The reaction time can be controlled from 10 minutes to 1 hour. After coating, the stainless steel strip surface was washed with DI water to remove the residue solution and dried in the oven at 80°C for 10 hours. An amorphous layer of (Co,Mn)Oₓ forms on the surface.

The stainless steel samples were calcined at 800° C for 2 hours to form the spinel layer on the surface. The samples undergo oxidation process in a tube furnace, with 3% H₂O humidified air at 800° C. The weights of samples were measured every 50 hours to study the corrosion kinetics.

### Example 2

This example was conducted to determine chromium evaporation. The calcined stainless steel samples were placed in a quartz tube and treated with 3%H₂O humidified air at 800^{o} C for 200 hours. The inside of the tube was cleaned with hydrochloric acid to collect redeposited volatile Cr species from the stainless steel. The chemical composition of solution was analyzed with ICP to quantify Cr evaporation during the corrosion test. FIG. 2 is a graph that depicts the effect of coating time on the oxidation behavior of stainless steel. FIG. 3 is a graph that depicts the effect of coating temperature on the oxidation behavior of stainless steel. FIG. 4 is a graph that depicts the effect of cobalt salt on the oxidation behavior of stainless steel. FIG. 5 is a graph that depicts the effect of Co:Mn ratio in the coating solution on the oxidation behavior of stainless steel.

### Example 3

This example was conducted to demonstrate the manufacturing of the NMC-γ-Al₂O₃ mixture. 1 grams of fumed nano γ-Al₂O₃ (average particle size 10 nm) and 100 grams of NMC (average particle size 13 micrometers) were added to a mixing jar. The nano γ-Al₂O₃ and NMC were processed using resonant acoustic mixing at 90G for 5 minutes to form the NMC-γ-Al₂O₃ mixture. The NMC-γ-Al₂O₃ mixture was used directly after its manufacture to form the cathode active material that contains the electrically conductive filler and the polymer in addition to the NMC-γ-Al₂O₃ mixture. This mixing is depicted in the schematic shown in FIG. 6, which shows NMC particles coated with a uniform coating of the γ-Al₂O₃ particles.

FIG. 7 depicts a series of scanning electron micrographs of NMC particles coated with γ-Al₂O₃ particles mixed for different periods of time. FIGS. 8 and 9 show a series of scanning electron micrographs of NMC particles coated with different amounts of γ-Al₂O₃ particles.

### Example 4

The electrodes were prepared by a solvent casting method. The NMC-γ-Al₂O₃ mixture from Example 3 was mixed with carbon black and poly (vinylidene difluoride) (PVDF) in an 8:1:1 weight ratio. The appropriate amount of N-methyl-2-pyrrolidone (NMP) was added to the NMC-γ-Al₂O₃ mixture, the electrically conducting filler and the polymer to form a slurry. The slurry was cast onto an aluminum foil and dried in vacuum at 120°C for 12 hours to form the cathode. The slurry upon drying forms the cathode active layer on the aluminum foil (which serves as the cathode current collector).

### Example 5

This example was conducted to demonstrate the formation of a coin cell. The cathode of Example 4 was cut into 12 millimeter discs and transferred into an argon filled glove box. The coin cells (2032 coin-type) were assembled with Li foil functioning as the anode electrode, Celgard film as the separator and suitable amount of electrolyte to form a lithium ion battery.

### Example 6

This example was conducted to determine the electrochemical performance of the surface coated cathode. The cycling performance of the cathode was evaluated at various current rates from 0.1 to 10 Coulombs with a battery testing system. The electrochemical impedance spectroscopy (EIS) and cyclic voltammetry will be tested with a potentiostat.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components can be included and called upon for providing for F of the teachings herein. For example, additional materials, combinations of materials and/or omission of materials can be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as invoking 35 U.S.C. §112(f) interpretations as “means-plus-function” language unless specifically expressed as such by use of the words “means for” or “steps for” within the respective claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there can be additional elements other than the listed elements. The term “exemplary” is not intended to be construed as a superlative example but merely one of many possible examples.

Unless defined otherwise, all technical and scientific terms used herein have the same meaning as commonly understood by one of ordinary skill in the art to which this invention belongs. The abbreviations used herein have their conventional meaning within the chemical and arts.

In the application, where an element or component is said to be included in and/or selected from a list of recited elements or components, it should be understood that the element or component can be any one of the recited elements or components, or the element or component can be selected from a group consisting of two or more of the recited elements or components.

Further, it should be understood that elements and/or features of a composition or a method described herein can be combined in a variety of ways without departing from the spirit and scope of the present invention, whether explicit or implicit herein. For example, where reference is made to a particular compound, that compound can be used in various embodiments of compositions of the present invention and/or in methods of the present invention, unless otherwise understood from the context. In other words, within this application, embodiments have been described and depicted in a way that enables a clear and concise application to be written and drawn, but it is intended and will be appreciated that embodiments can be variously combined or separated without parting from the present teachings and invention(s). For example, it will be appreciated that all features described and depicted herein can be applicable to all aspects of the invention(s) described and depicted herein.

In other words, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In the disclosure herein of any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Accordingly, any means which can provide those functionalities can be regarded as equivalent to those shown herein. No functional language used in claims appended herein is to be construed as invoking 35 U.S.C. § 112(f) interpretations as “means-plus-function” language unless specifically expressed as such by use of the words “means for” or “steps for” within the respective claim.

It should be understood that the expression “at least one of” includes individually each of the recited objects after the expression and the various combinations of two or more of the recited objects unless otherwise understood from the context and use. The expression “and/or” in connection with three or more recited objects should be understood to have the same meaning unless otherwise understood from the context.

The use of the term “include,” “includes,” “including,” “have,” “has,” “having,” “contain,” “contains,” or “containing,” including grammatical equivalents thereof, should be understood generally as open-ended and non-limiting, for example, not excluding additional unrecited elements or steps, unless otherwise specifically stated or understood from the context.

Where the use of the term “about” is before a quantitative value, the present invention also includes the specific quantitative value itself, unless specifically stated otherwise. As used herein, the term “about” refers to a ±10% variation, a ±5% variation, or a ±2.5% variation from the nominal value as understood from the context, unless otherwise indicated or inferred from the context.

At various places in the present specification, values are disclosed in groups or in ranges. It is specifically intended that the description include each and every individual sub-combination of the members of such groups and ranges. For example, an integer in the range of 0 to 40 is specifically intended to individually disclose 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31 32, 33, 34, 35, 36, 37, 38, 39, and 40, and an integer in the range of 1 to 20 is specifically intended to individually disclose 1, 2, 3, 4, 5, 6, 7, 8, 9, 10, 11, 12, 13, 14, 15, 16, 17, 18, 19, and 20.

The use of any and all examples, or exemplary language herein, for example, “such as” or “including,” is intended merely to illustrate better the present invention and does not pose a limitation on the scope of the invention unless claimed. The examples provided herein are intended solely for illustrative purposes and are not to be interpreted as restricting the disclosed subject matter to the specific embodiments presented. No language in the specification should be construed as indicating any non-claimed element as essential to the practice of the present invention.

Throughout the description, where compositions and kits are described as having, including, or comprising specific components, or where processes and methods are described as having, including, or comprising specific steps, it is contemplated that, additionally, there are compositions and kits of the present invention that consist essentially of, or consist of, the recited components, and that there are processes and methods according to the present invention that consist essentially of, or consist of, the recited processing steps.

As a general matter, compositions specifying a percentage are by weight unless otherwise specified.

Any particular embodiment of the present teachings that falls within the prior art can be explicitly excluded from any one or more of the claims. Because such embodiments are deemed to be known to one of ordinary skill in the art, they can be excluded even if the exclusion is not set forth explicitly herein. Any particular embodiment of the disclosure can be excluded from any claim, for any reason, whether or not related to the existence of prior art.

The disclosure can be embodied in other specific forms without departing from the spirit or essential characteristics thereof. The foregoing embodiments are therefore to be considered in all respects illustrative rather than limiting the disclosure described herein. Scope of the disclosure is thus indicated by the appended claims rather than by the foregoing description, and all changes that come within the meaning and range of equivalency of the claims are intended to be embraced therein.

What is claimed is:

1. An electrochemical component of an electrochemical cell, the electrochemical component comprising:
a substrate forming at least a portion of an electrochemical component; and
a protective surface region disposed on the electrochemical component,
wherein the protective surface region comprises a porous layer of at least one degradation retardant to inhibit a degradation mechanism of the electrochemical component during operation of an electrochemical device.

2. The electrochemcial component of claim 1, wherein the degradation mechanism comprises chromium evaporation, stainless steel oxidation, an interfacial side reaction, transition metal dissolution, electrolyte decomposition, gas evolution, or a combination thereof.

3. The electrochemical component of claim 1, wherein the substrate is stainless steel.

4. The electrochemical component of claim 3, wherein the stainless steel component comprises a metallic interconnect of a solid oxide fuel cell.

5. The electrochemical component of claim 3, wherein the at least one degradation retardant comprises metal oxide particles comprising cobalt and manganese.

6. The electrochemical component of claim 5, wherein the metal oxide particles comprise an oxide of cobalt and manganese.

7. The electrochemical component of claim 5, wherein the cobalt and manganese are present in a stoichiometric molar ratio of 0.1:0.9 to 0.9 to 0.1.

8. The electrochemical component of claim 6, wherein the oxide of cobalt and manganese has the formula: (Co,Mn)Oₓ wherein x is 1 to 2.

9. The electrochemical component of claim 8, wherein x is 1.33 to 1.9.

10. The electrochemical component of claim 1, wherein the protective surface region comprises a spinel layer.

11. The electrochemical component of claim 1, wherein the substrate comprises micron sized lithium cathode particles.

12. The electrochemical component of claim 11, wherein the micron sized lithium cathode particles comprise nickel manganese cobalt oxide, nickel cobalt aluminum oxide, lithium cobalt oxide, or a combination thereof.

13. The electrochemical component of claim 12, wherein the micron sized lithium cathode particles have an average particle size of 5 micrometers to 40 micrometers.

14. The electrochemical component of claim 12, wherein the metal oxide particles comprise a nickel manganese cobalt oxide mixture comprising nanometer sized oxide particles.

15. The electrochemical component of claim 14, wherein the nanometer sized oxide particles comprise gamma alumina (γ-Al₂O₃), titania (TiO₂), zirconia₍ZrO₂), silica (SiO₂), tungsten oxide (WO₃), or combinations thereof.

16. The electrochemical component of claim 14, wherein the nanometer sized oxide particles have an average particle size of 2 to 20 nanometers.

17. The electrochemical component of claim 1, wherein the at least one degradation retardant comprises a porous layer of metal oxide particles.

18. An electrochemical cell comprising:
an anode;
a cathode;
an electrolyte in electrical communication with each of the anode and the cathode; and
an electrochemical component comprising:
a substrate forming at least a portion of an electrochemical component; and
a protective surface region disposed on the electrochemical component,
wherein the protective surface region comprises at least one degradation retardant to inhibit a degradation mechanism of the electrochemical component during operation of the electrochemical cell.

19. The electrochemical cell of claim 17, wherein the substrate is selected from a stainless steel interconnect, and a stainless steel component of a gas manifold, a compression plate, a current collector, and a sealing structure.

20. The electrochemical cell of claim 17, wherein the substrate comprises micron sized lithium cathode particles.
